(19) United States
(12) Patent Application Publication
(10) Pub. No.: US 2013/0224421 A1
(43) Pub. Date: Aug. 29, 2013

(54) SINTERED MAGNESIUM OXIDE MATERIAL, AND PROCESS FOR PRODUCTION THEREOF

(71) Applicants: Tadasuke Kamei, Hyogo (JP); Takuji Tsujita, Osaka (JP); Jun Hashimoto, Osaka (JP); Takayuki Shimamura, Osaka (JP); Masashi Goto, Osaka (JP)

(72) Inventors: Tadasuke Kamei, Hyogo (JP); Takuji Tsujita, Osaka (JP); Jun Hashimoto, Osaka (JP); Takayuki Shimamura, Osaka (JP); Masashi Goto, Osaka (JP)

(73) Assignees: PANASONIC CORPORATION, Osaka (JP); TATEHO CHEMICAL INDUSTRIES CO., LTD., Hyogo (JP)

(21) Appl. No.: 13/697,764

(22) PCT Filed: Apr. 11, 2011
(86) PCT No.: PCT/JP2011/002133

§ 371 Date: Apr. 26, 2013

(30) Foreign Application Priority Data
May 20, 2010 (JP) 2010-116160

(51) Int. Cl. C04B 35/04

(52) U.S. Cl. CPC C04B 35/04
USPC 428/64.1; 428/80; 428/81; 264/669

(57) ABSTRACT

Disclosed herein are a sintered magnesium oxide material which is capable of suppressing the occurrence of splashing during film formation and which is less likely to cause clogging of a supply inlet of a film formation device, a deposition material for PDP-protecting film using the same, and a process for producing the sintered material. The sintered magnesium oxide material contains magnesium oxide, 3 to 50 mass % of an oxide of a Group 2A element other than magnesium in the periodic table, and if necessary, 1000 ppm or less of one or two or more elements selected from the group consisting of aluminum, yttrium, cerium, zirconium, scandium, and chromium, and has a disk-like, elliptical plate-like, polygonal plate-like, or half-moon-like shape or a cubic or rectangular solid shape with rounded apexes.

### TECHNICAL FIELD

The present invention relates to a magnesium oxide sintered body suitable as an evaporation material capable of forming a protective film for plasma display panel (hereinafter, referred to as “PDP”) and a method for producing the same.

### BACKGROUND ART

A PDP is a display device in which a plurality of sealed micro discharge spaces are provided between two glass substrates. For example, in the case of a matrix display type PDP, a plurality of electrodes are arranged in a grid pattern, and discharge cells at the intersections of the electrodes selectively emit light to display images. In a typical surface discharge type AC PDP, display electrodes provided on a front panel are covered with a dielectric layer, and a protective film is further formed on the dielectric layer. The protective film plays a role in preventing the dielectric layer from being directly exposed to electric discharge to prevent a rise in discharge starting voltage caused by the surface change of the dielectric layer, and therefore has the property that it is resistant to sputtering by ion bombardment.

Currently, a PDP protective film is generally formed on a dielectric layer by electron-beam evaporation using a sintered material, such as a sintered magnesium oxide material, as a target material. However, PDPs are required to have a lower discharge starting voltage to further save electric power. Therefore, there is a demand for a material for forming a PDP protective film that has a low discharge starting voltage and a high secondary electron emission coefficient and is resistant to sputtering.

From such a viewpoint, evaporation materials composed of high-purity magnesium oxide have been proposed as materials for forming a protective film (see Patent Documents 1 to 3). These materials for protective film are preferred because they have a relatively low discharge starting voltage and excellent sputtering resistance.

Patent Document 1 discloses a magnesium oxide evaporation material having a magnesium oxide purity of 99.0% or higher, a relative density of 90.0% or higher, and an external volume of 35 to 1500 mm³.

Patent Document 2 discloses a magnesium oxide evaporation material having a surface roughness Ra of 1.0 μm to 10 μm, a real surface area of 200 mm² to 1200 mm², an external volume of 30 mm³ to 1500 mm³, a specific surface area of 20 cm²/g to 100 cm²/g, a magnesium oxide purity of 99.0% or higher, and a relative density of 90.0% or higher.

Patent Document 3 discloses a magnesium oxide evaporation material having a magnesium oxide purity of 99.0% or higher, a relative density of 90.0% or higher, and an external volume of 35 mm³ to 1500 mm³.

### PRIOR ART DOCUMENTS

### Patent Documents

Patent Document 1: JP-A-2004-43955
Patent Document 2: JP-A-2004-43956
Patent Document 3: JP-A-2008-274442

### DISCLOSURE OF THE INVENTION

### Problems to be Solved by the Invention

When a magnesium oxide sintered body as an evaporation material has a cubic or rectangular solid shape having sharp projections at its eight apexes, point contact occurs between the sintered bodies at their apexes. Therefore, heat generated by electron beam irradiation during evaporation is less likely to diffuse and splashing is likely to occur due to rapid local heating. If splashing frequently occurs, the evaporation material is adhered to the surface of film, which causes a problem that a PDP has a problem with image display.

Further, when containing calcium oxide, a magnesium oxide sintered body as an evaporation material is inferior in surface smoothness to a high-purity magnesium oxide sintered body, and therefore friction is likely to occur and flowability is poor. This causes a problem that when the evaporation material is supplied to a film formation device, friction or bridging occurs so that a supply inlet is easily clogged with the evaporation material.

It is therefore an object of the present invention to provide a magnesium oxide sintered body which is capable of, when used as an evaporation material, suppressing the occurrence of splashing during film formation and which is less likely to cause clogging of a supply inlet of film formation device when supplied to the film formation device, an evaporation material for PDP protective film using the same, and a method for producing the sintered body.

### Means for Solving the Problems

In order to achieve the above object, the present inventors have extensively studied and found that the use of, as an evaporation material, a magnesium oxide sintered body which contains magnesium oxide and a specific amount of an oxide of a Group 2A element other than magnesium in the periodic table and which has a disk-like, elliptical plate-like, polygonal plate-like, or half-moon-like shape or a cubic or rectangular solid shape with rounded apexes makes it possible to suppress the occurrence of splashing during film formation to prevent a PDP from having a problem with image display caused by adhesion of splashes of the evaporation material. Further, the present inventors have also found that such an evaporation material is less likely to cause clogging of a supply inlet of film formation device when supplied to the film formation device. These findings have led to the completion of the present invention.

More specifically, the present invention is directed to a magnesium oxide sintered body including magnesium oxide and 3 to 50 mass % of an oxide of a Group 2A element other than magnesium in the periodic table, the magnesium oxide sintered body having a disk-like, elliptical plate-like, polygonal plate-like, or half-moon-like shape or a cubic or rectangular solid shape with rounded apexes.

The present invention is also directed to an evaporation material for protective film for plasma display panel, the evaporation material including the magnesium oxide sintered body.

The present invention is also directed to a method for producing the magnesium oxide sintered body, the method including the steps of: mixing a magnesium-containing compound powder, a compound powder containing a Group 2A element other than magnesium in the periodic table, and a binder to prepare a mixture; granulating and drying the mixture to obtain a granulated powder; molding the granulated powder in a mold to form a molded body; and sintering the molded body.

### Effects of the Invention

The magnesium oxide sintered body according to the present invention has a disk-like, elliptical plate-like, polygonal plate-like, or half-moon-like shape or a cubic or rectangular solid shape with eight rounded apexes, and therefore has less sharp projections as compared to a normal cube or rectangular solid, and makes it possible to avoid local heating caused by electron beam irradiation during evaporation and therefore to suppress the occurrence of splashing. Further, the magnesium oxide sintered body having such a shape as described above is less likely to cause clogging of a supply inlet of film formation device when supplied to the film formation device.

### BRIEF DESCRIPTION OF THE DRAWINGS

FIG. 1 is a perspective view of a magnesium oxide sintered body according to the present invention having a disk-like shape.

FIG. 2 is a perspective view of a magnesium oxide sintered body having a normal rectangular solid shape (comparative example).

FIG. 3 is a perspective view of a magnesium oxide sintered body according to the present invention having a rectangular solid shape with rounded apexes.

FIG. 4 is a top view of a device for checking the flowability of sintered bodies.

### MODE FOR CARRYING OUT THE INVENTION

A magnesium oxide sintered body according to the present invention mainly contains magnesium oxide and further contains an oxide of a Group 2A element other than magnesium in the periodic table. The term “sintered body” refers to a dense molded body produced by heating a powder aggregate at a temperature lower than a melting point so that powder grains are connected to each other by solid-state diffusion, neck growth, and grain boundary motion.

Examples of the Group 2A element other than magnesium in the periodic table include calcium, beryllium, strontium, barium, and radium. These elements may be used singly or in combination of two or more of them. Among them, calcium is preferred because calcium has a small band gap, which is highly effective in reducing a discharge starting voltage.

The amount of the oxide of a Group 2A element other than magnesium in the periodic table contained in the magnesium oxide sintered body according to the present invention is 3 to 50 mass %. If the amount of the oxide contained in the magnesium oxide sintered body is less than 3 mass %, the voltage reduction effect is poor. On the other hand, if the amount of the oxide contained in the magnesium oxide sintered body exceeds 50 mass %, the strength of the sintered body is drastically reduced so that splashing is likely to occur and clogging of a supply inlet of film formation device is also likely to occur. Therefore, the amount of the oxide contained in the magnesium oxide sintered body is preferably 5 to 35 mass %, more preferably 9 to 25 mass %.

Further, as a sintering aid, one or two or more elements selected from the group consisting of aluminum, yttrium, cerium, zirconium, scandium, and chromium may be added to the magnesium oxide sintered body according to the present invention in an amount of 1000 ppm or less. Addition of the sintering aid improves the smoothness of the surface of the sintered body. However, when the sintering aid is added in a large amount, the properties of a PDP protective film are degraded. Therefore, the amount of the sintering aid to be added is preferably 500 ppm or less, more preferably 300 ppm or less.

The magnesium oxide sintered body according to the present invention has a disk-like, elliptical plate-like, polygonal plate-like, or half-moon-like shape or a cubic or rectangular solid shape with rounded apexes, and therefore has less sharp projections as compared to a normal cube or rectangular solid. Therefore, during evaporation by electron beam irradiation, an electron beam is less likely to concentrate on a certain point. This makes it possible to suppress the occurrence of splashing. Further, when containing calcium oxide, the magnesium oxide sintered body is poor in surface smoothness, and therefore friction is likely to occur. However, as described above, since the magnesium oxide sintered body according to the present invention has a disk-like, elliptical plate-like, polygonal plate-like, or half-moon-like shape or a cubic or rectangular solid shape with rounded apexes, flowability is improved, and therefore when the magnesium oxide sintered body is supplied to a film formation device as an evaporation material, clogging of a supply inlet of the film formation device is less likely to occur.

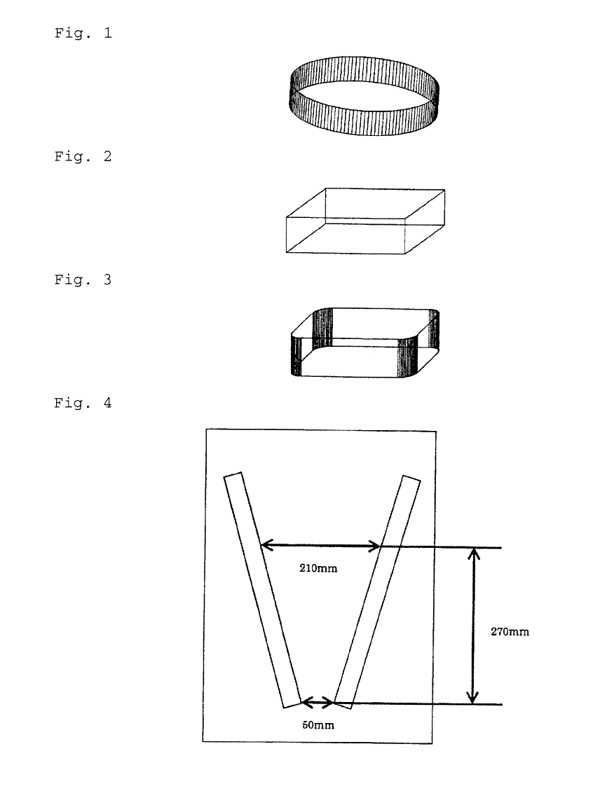

FIG. 1 is a perspective view of the magnesium oxide sintered body according to the present invention having a disk-like shape. As shown in FIG. 1, the disk-like shape refers to a circular plate-like shape. The elliptical plate-like shape is similar to the disk-like shape except that its top and bottom surfaces are elliptical. The polygonal plate-like shape is similar to the disk-like shape except that its top and bottom surfaces are polygonal. The half-moon-like shape is similar to the disk-like shape except that its top and bottom surfaces are semicircular (i.e., a shape obtained by dividing a circle into two along its diameter).

FIG. 2 is a perspective view of a magnesium oxide sintered body having a normal rectangular solid shape (comparative example), and FIG. 3 is a perspective view of a magnesium oxide sintered body according to the present invention having a rectangular solid shape with rounded apexes. As shown in FIG. 3, the rectangular solid shape with rounded apexes refers to a shape of a substantially rectangular solid whose eight apexes are shaved and rounded.

The magnesium oxide sintered body according to the present invention preferably has a relative density of 80% or higher.

Hereinbelow, a method for producing the magnesium oxide sintered body according to the present invention will be described.

The magnesium oxide sintered body according to the present invention can be produced through the steps of: mixing a magnesium-containing compound powder, a compound powder containing a Group 2A element other than magnesium in the periodic table, and a binder to prepare a mixture; granulating and drying the mixture to obtain a granulated powder; molding the granulated powder in a mold to form a molded body; and sintering the molded body. A sintered body containing also one or two or more elements selected from the group consisting of aluminum, yttrium, cerium, zirconium, scandium, and chromium can be produced by further adding a compound containing one or two or more elements selected from the group consisting of aluminum, yttrium, cerium, zirconium, scandium, and chromium in the step of preparing a mixture. Examples of the magnesium-containing compound include magnesium oxide, magnesium carbonate, and magnesium hydroxide. Examples of the compound containing a Group 2A element other than magnesium in the periodic table include oxides, carbonates, and hydroxides of Group 2A elements other than magnesium in the periodic table. Examples of the compound containing one or two or more elements selected from the group consisting of aluminum, yttrium, cerium, zirconium, scandium, and chromium include oxides, carbonates, and hydroxides of one or two or more elements selected from the group consisting of aluminum, yttrium, cerium, zirconium, scandium, and chromium.

More specifically, first, the D₅₀ particle size of a raw material compound powder such as a high-purity (e.g., 99.9% or higher) magnesium oxide, carbonate, or hydroxide powder is adjusted to about 0.1 to 10 μm, preferably about 0.2 to 2 μm.

At the same time, the D₅₀ particle size of a compound powder such as a powder of a high-purity (e.g., 99% or higher, preferably 99.9% or higher) oxide, carbonate, or hydroxide of a Group 2A element other than magnesium in the periodic table is preferably adjusted to about 1 to 20 μm.

These powders are mixed in a predetermined weight ratio, and a resin binder solution is further added in an appropriate amount thereto and sufficiently mixed to obtain a mixture, and the mixture is subjected to granulation to obtain granules. The granulation can be performed by a tumbling granulation method, a spray granulation method, or the like. The obtained granules are dried and then fed into a predetermined mold and molded to obtain a molded body having a disk-like, elliptical plate-like, polygonal plate-like, or half-moon-like shape or a cubic or rectangular solid shape with rounded apexes. The molding can be performed by, for example, a uniaxial pressing machine. A mold pressure is preferably set to, for example, 0.01 to 600 MPa to adjust the relative density of a resulting molded body.

Then, the obtained molded body is fired to obtain a magnesium oxide sintered body according to the present invention. The firing is preferably performed at a temperature of 1300 to 1800° C. for 0.5 to 20 hours. The firing can be performed in an electric furnace, a gas furnace, or the like.

The resin binder is not particularly limited. For example, a binder composed of CMC (carboxy methyl cellulose), PVA (polyvinyl alcohol), an acrylic resin, or a vinyl acetate-based resin can be used. The amount of the resin binder to be used is about 1 to 10 parts by weight as solid per 100 parts by weight, calculated as oxides, of the total amount of the powders. The concentration of the binder is preferably about 5 to 50%.

The magnesium oxide sintered body according to the present invention is suitable for use as an evaporation material used as a raw material for forming a protective film for plasma display panel by a vacuum vapor deposition method such as an electron-beam evaporation method, an ion plating method, or a sputtering method. The use of the magnesium oxide sintered body according to the present invention makes it possible to achieve excellent energy efficiency during evaporation while suppressing the occurrence of splashing causing defects, which makes it possible to produce a protective film having excellent film properties.

### EXAMPLES

Hereinbelow, the present invention will be described in more detail with reference to the following examples, but is not limited thereto.

### Example 1

A calcium carbonate powder (purity: 99.99%, D₅₀ particle size (volume median diameter): 8.63 μm) was added to 90 g of a magnesium oxide powder (purity: 99.9%, D₅₀ particle size: 0.5 μm) in such an amount that the calcium oxide content of a resulting sintered body was 10 wt %. Then, an organic solvent was added in an amount of 100 to 200 wt % based on the weight of a mixture of the magnesium oxide powder and the calcium carbonate powder. The thus obtained mixture was placed in a resin pot containing nylon balls and was pulverized and mixed for 8 hours.

After the completion of pulverization and mixing, an acrylic binder solution diluted with an organic solvent to 30% was added to the resin pot in an amount of 2 to 10 wt %, calculated as solid, based on the weight of a mixture of the magnesium oxide powder and the calcium carbonate powder, and they were mixed for 30 minutes to prepare a slurry.

The prepared slurry was spray-dried by a spray drier to prepare granules, and the granules were fed into a predetermined mold and molded by a uniaxial pressing machine at a pressure of 400 MPa to obtain a molded body.

After the completion of molding, the molded body was subjected to a degreasing process in a gas furnace in an air atmosphere under conditions of 300° C. and 1 hour, and was then subjected to a firing process at 1600° C. for 8 hours to obtain a disk-like sintered body having a diameter of 6.0 mm and a thickness of 2.5 mm.

As an evaporation material, 10 kg of the thus obtained magnesium oxide sintered bodies containing calcium oxide were fed into a hearth, and then a thin film was formed on a substrate by evaporation using an electron beam evaporation device at an output of 18 kV at 900 mA for 15 minutes. During the film formation, the evaporation material was visually observed through a viewport to determine whether or not splashing occurred, and after the completion of film formation, the surface of the thin film was observed, and evaluation was made according to the following three criteria.

⊙: Splashing was not observed and adhesion of splashes of the evaporation material to the film surface was not observed, either.
◯: Splashing was observed but adhesion of splashes of the evaporation material to the film surface was not observed.
X: Splashing was frequently observed and adhesion of splashes of the evaporation material to the film surface was also observed.

Further, the flowability of the sintered bodies to be supplied to a film formation device was examined in the following manner. As shown in FIG. 4, two stainless steel rods were placed on a stainless steel plate tilted at 35°, and the sintered bodies were fed as an evaporation material between the two rods to evaluate the flowability of the sintered bodies according to the following three criteria.

◯: The evaporation material was smoothly supplied and bridging (i.e., formation of a cluster of two or more sintered bodies pushing against each other in a supply tube) did not occur.
Δ: The evaporation material was smoothly supplied, but bridging occurred.
X: The evaporation material was not smoothly supplied, and bridging also occurred.

Method for Measuring Maximum Static Frictional Force

The frictional force of the sintered body was determined in the following manner. The sintered body was placed in a stainless steel trench whose tilt angle was variable, and a force exerted on the sintered body was calculated as maximum static frictional force (F) from an angle θ, at which the sintered body was started to slide, by the following calculation formula.

F(X10⁻³N)=μ·m·g·cos θ

μ: coefficient of static friction (calculated from the relationship μ=tan θ)

m: weight of sintered body

g: gravitational acceleration

Method for Measuring Calcium Oxide Concentration

The concentration of calcium oxide in the sintered body was measured by analyzing a solution obtained by dissolving a sample in an acid with an ICP emission spectrometer (manufactured by Agilent, Type 4500).

### Example 2

A magnesium oxide sintered body was produced and evaluated in the same manner as in Example 1 except that the calcium oxide content of the sintered body was changed to 3 wt % and the shape of the sintered body was changed to a disk-like shape having a diameter of 8.0 mm and a thickness of 3.0 mm.

### Example 3

A magnesium oxide sintered body was produced and evaluated in the same manner as in Example 1 except that the calcium carbonate powder was changed to a calcium hydroxide powder, the calcium oxide content of the sintered body was changed to 15 wt %, and the shape of the sintered body was changed to a disk-like shape having a diameter of 10 mm and a thickness of 3.5 mm.

### Example 4

A magnesium oxide sintered body was produced and evaluated in the same manner as in Example 1 except that the calcium oxide content of the sintered body was changed to 25 wt %.

### Example 5

A magnesium oxide sintered body was produced and evaluated in the same manner as in Example 1 except that the calcium carbonate powder was changed to a calcium hydroxide powder, the calcium oxide content of the sintered body was changed to 35 wt %, and the shape of the sintered body was changed to a disk-like shape having a diameter of 8 mm and a thickness of 3.0 mm.

### Example 6

A magnesium oxide sintered body was produced and evaluated in the same manner as in Example 1 except that the calcium oxide content of the sintered body was changed to 45 wt % and the shape of the sintered body was changed to a disk-like shape having a diameter of 10 mm and a thickness of 3.5

### Example 7

A magnesium oxide sintered body was produced and evaluated in the same manner as in Example 1 except that the shape of the sintered body was changed to a rectangular solid shape with rounded apexes and a size of 4 mm×4 mm×2.5 mm.

### Example 8

A magnesium oxide sintered body was produced and evaluated in the same manner as in Example 1 except that the calcium carbonate powder was changed to a calcium hydroxide powder, the calcium oxide content of the sintered body was changed to 25 wt %, and the shape of the sintered body was changed to a rectangular solid shape with rounded apexes and a size of 8 mm×8 mm×3.5 mm.

### Example 9

A magnesium oxide sintered body was produced and evaluated in the same manner as in Example 1 except that the calcium oxide content of the sintered body was changed to 45 wt % and the shape of the sintered body was changed to a rectangular solid shape with rounded apexes and a size of 8 mm×4 mm×3.5 mm.

### Comparative Example 1

A magnesium oxide sintered body was produced and evaluated in the same manner as in Example 1 except that the shape of the sintered body was changed to a rectangular solid shape with sharp apexes (i.e. a normal rectangular solid shape) and a size of 4 mm×4 mm×2.5 mm.

### Comparative Example 2

A magnesium oxide sintered body was produced and evaluated in the same manner as in Example 1 except that the shape of the sintered body was changed to a rectangular solid shape with sharp apexes and a size of 8 mm×4 mm×3.5 mm.

### Comparative Example 3

A magnesium oxide sintered body was produced and evaluated in the same manner as in Example 1 except that the calcium oxide content of the sintered body was changed to 20 wt % and the shape of the sintered body was changed to a rectangular solid shape with sharp apexes and a size of 8 mm×8 mm×3.5 mm.

### Comparative Example 4

A magnesium oxide sintered body was produced and evaluated in the same manner as in Example 1 except that the calcium oxide content of the sintered body was changed to 20 wt % and the shape of the sintered body was changed to a rectangular solid shape with sharp apexes and a size of 10 mm×5 mm×3.5 mm.

The evaluation results are shown in Table 1.

TABLE 1

| | | | | | | Maximum | | |
|---|---|---|---|---|---|---|---|---|
| | | | Shape of | | | Static | | |
| | Raw | CaO | Evaporation | | | Frictional | | |
| | Material | (%) | Material | Size | Thickness | Force | Splashing | Flowability |
| Example 1 | Calcium | 10 | Disk | φ 6 mm | 2.5 mm | 0.96 | ⊙ | ◯ |
| | carbonate | | | | | | | |
| Example 2 | Calcium | 3 | Disk | φ 8 mm | 3.0 mm | 0.74 | ⊙ | ◯ |
| | carbonate | | | | | | | |
| Example 3 | Calcium | 15 | Disk | φ 10 mm | 3.5 mm | 1.15 | ⊙ | ◯ |
| | hydroxide | | | | | | | |
| Example 4 | Calcium | 25 | Disk | φ 6 mm | 2.5 mm | 1.23 | ⊙ | ◯ |
| | carbonate | | | | | | | |
| Example 5 | Calcium | 35 | Disk | φ 8 mm | 3.0 mm | 1.23 | ⊙ | ◯ |
| | hydroxide | | | | | | | |
| Example 6 | Calcium | 45 | Disk | φ 10 mm | 3.5 mm | 1.26 | ⊙ | ◯ |
| | carbonate | | | | | | | |
| Example 7 | Calcium | 10 | Rectangular | 4 mm × 4 mm | 2.5 mm | 0.98 | ◯ | ◯ |
| | carbonate | | solid with | | | | | |
| | | | rounded | | | | | |
| | | | apexes | | | | | |
| Example 8 | Calcium | 25 | Rectangular | 8 mm × 8 mm | 3.5 mm | 1.13 | ◯ | ◯ |
| | hydroxide | | solid with | | | | | |
| | | | rounded | | | | | |
| | | | apexes | | | | | |
| Example 9 | Calcium | 45 | Rectangular | 8 mm × 4 mm | 3.5 mm | 1.26 | ◯ | ◯ |
| | carbonate | | solid with | | | | | |
| | | | rounded | | | | | |
| | | | apexes | | | | | |
| Comparative | Calcium | 10 | Rectangular | 4 mm × 4 mm | 2.5 mm | 1.01 | X | Δ |
| Example 1 | carbonate | | solid with | | | | | |
| | | | sharp apexes | | | | | |
| Comparative | Calcium | 10 | Rectangular | 8 mm × 4 mm | 3.5 mm | 1.12 | X | X |
| Example 2 | carbonate | | solid with | | | | | |
| | | | sharp apexes | | | | | |
| Comparative | Calcium | 20 | Rectangular | 8 mm × 8 mm | 3.5 mm | 1.20 | X | X |
| Example 3 | carbonate | | solid with | | | | | |
| | | | sharp apexes | | | | | |
| Comparative | Calcium | 20 | Rectangular | 10 mm × 5 mm | 3.5 mm | 1.25 | X | X |
| Example 4 | carbonate | | solid with | | | | | |
| | | | sharp apexes | | | | | |

As can be seen from Table 1, the magnesium oxide sintered bodies of Examples 1 to 9 can suppress the occurrence of splashing during film formation, and exhibit excellent flowability when supplied to a film formation device.

1. A magnesium oxide sintered body comprising magnesium oxide and 3 to 50 mass % of an oxide of a Group 2A element other than magnesium in the periodic table, the magnesium oxide sintered body having a disk-like, elliptical plate-like, polygonal plate-like, or half-moon-like shape or a cubic or rectangular solid shape with rounded apexes.

2. The magnesium oxide sintered body according to claim 1, wherein the Group 2A element other than magnesium in the periodic table is one or two or more selected from the group consisting of calcium, beryllium, strontium, barium, and radium.

3. The magnesium oxide sintered body according to claim 2, wherein the Group 2A element other than magnesium in the periodic table is calcium.

4. The magnesium oxide sintered body according to claim 1, further comprising one or two or more elements selected from the group consisting of aluminum, yttrium, cerium, zirconium, scandium, and chromium in an amount of 1000 ppm or less.

5. The magnesium oxide sintered body according to claim 1, whose relative density is 80% or higher.

6. An evaporation material for protective film for plasma display panel, comprising the magnesium oxide sintered body according to claim 1.

7. A method for producing the magnesium oxide sintered body according to claim 1, the method comprising the steps of:
mixing a magnesium-containing compound powder, a compound powder containing a Group 2A element other than magnesium in the periodic table, and a binder to prepare a mixture;
granulating and drying the mixture to obtain a granulated powder;
molding the granulated powder in a mold to form a molded body; and
sintering the molded body.

8. A method for producing the magnesium oxide sintered body according to claim 1, the method comprising the steps of:
mixing a magnesium-containing compound powder, a compound powder containing a Group 2A element other than magnesium in the periodic table, a compound powder containing one or two or more elements selected from the group consisting of aluminum, yttrium, cerium, zirconium, scandium, and chromium, and a binder to prepare a mixture;
granulating and drying the mixture to obtain a granulated powder;
molding the granulated powder in a mold to form a molded body; and
sintering the molded body.
